(19) United States
(12) Patent Application Publication
(10) Pub. No.: US 2004/0079071 A1
(43) Pub. Date: Apr. 29, 2004

(54) Fuel injection system for a gas turbine

(76) Inventors: Johnny Rehn, Limhamn (SE); Jan Magnusson, Malmo (SE); Alf Andersson, Oxie (SE)

Correspondence Address: Steven S. Payne, Law Office of Steven S. Payne, 8027 ILIFF Drive, Dunn Loring, VA, 22027, US

(21) Appl. No.: 10/281,188

(22) Filed: Oct. 28, 2002

(51) Int. Cl. F02C 3/22

(52) U.S. Cl. 60/39.465

(57) ABSTRACT

A gas turbine has a fuel injection system for supplying pressurized fuel gas to a combustion chamber of a gas turbine. The fuel injection system has at least one electrically controllable magnetic valve working with pulse-width modulation, i.e., controlling the gas flow by varying the length of its opening time pulses in relation to its closing time, in a gas supply conduit. The fuel injection system has at least one electrically controllable magnetic main valve arranged in the supply conduit. Moreover, at least one pilot valve is connected to the supply conduit with its upstream end after the main valve and with its downstream end connected to a conduit leading into a pilot flame chamber inside the combustion chamber.

### TECHNICAL FIELD

The present invention relates to a fuel injection system for supplying pressurized fuel gas to a combustion chamber of a gas turbine. The fuel injection system has at least one electrically controllable magnetic valve working with pulse-width-modulation, i e controlling the gas flow by varying the length of its opening time pulses in relation to its closing time, in a gas supply conduit. It also relates to methods for operating and starting a gas turbine by means of such a fuel injection system.

### DESCRIPTION OF THE PRIOR ART

A combustion chamber of a gas turbine can be supplied with different fuels, e g solid fuels that have been pretreated into gaseous form, liquid fuels that are injected as a fine dispersion, or originally gaseous fuels. Fuels in liquid form or gas form are the most widely used types for operating a gas turbine. Different fuels require different fuel systems.

The problems with most of these earlier fuel systems are their complicated construction, maintenance and associated high costs.

### SUMMARY OF THE INVENTION

The main objects of the present invention are to simplify the construction of fuel systems, and to reduce their costs.

These objects are achieved for a fuel system by a fuel injection system for supplying pressurized fuel gas to a combustion chamber of a gas turbine. The fuel injection system has at least one controllable valve in a gas supply conduit. Each valve is an electrically controllable magnetic valve working with pulse-width-modulation, i e controlling the fuel gas mass flow by varying the length of its opening time pulses in relation to its closing time.

The objects are also achieved by methods for operating and starting a gas turbine by means of such a fuel injection system. The fuel injection system also comprises at least one fuel gas igniter, at least one fuel gas injection nozzle in the combustion chamber, and at least one pilot valve and a throttle valve in the gas supply conduit. The methods comprise the steps of evacuating fuel gas in the combustion chamber. Then the igniter is energized before pressurized fuel gas is supplied in the gas supply conduit. This is followed by igniting the fuel gas supplied from the gas supply conduit through the throttle valve, whereby a pilot flame is created, and waiting until the pilot flame is stable. Then the pilot valve is energized so that the pilot flame can be regulated for achieving a predefined temperature in the combustion chamber, and the main valves are energized and the pilot valve is closed, alternatively, regulated when the combustion chamber has an appropriate temperature.

By providing a fuel injection system with at least one valve according to the invention and/or operating and starting a gas turbine according to the methods as defined, the following advantages are obtained: the construction of a fuel system is simplified by means of easy obtainable standard valves, its cost is reduced due to low prices for valves and their associated equipment, and the operation of the gas turbine is secure and easy regulated.

Other objects, features and advantages of the present invention are disclosed in the subsequent detailed disclosure, and in the drawings as well as in the appended claims.

### BRIEF DESCRIPTION OF THE DRAWINGS

The present invention will now be described in further detail, reference being made to the accompanying drawings, in which:

FIG. 1 is a flow diagram of a preferred embodiment of a fuel injection system according to the invention,

FIG. 2 is diagrams over a temperature profile in a combustion chamber of a gas turbine, and fuel gas mass flow into the combustion chamber during injection of fuel gas in accordance with the invention,

FIG. 3 is a diagram showing the operation of the main valves in the fuel injection system according to the invention when each valve is open 50% of the period time during the injection of fuel gas, and

FIG. 4 is a diagram showing the operation of the main valves in the fuel injection system according to the invention when each valve is open 20% of the period time during the injection of fuel gas.

### DETAILED DESCRIPTION OF THE INVENTION

The easiest way of controlling a gas turbine unit is by changing the mass flow of fuel to the gas turbine. This can be done by regulating the injection of a pressurized fuel, which, if a liquid fuel is used, is pressurized by a separate pump or, if a gaseous fuel is used, by a separate compressor of a centrifugal, axial, screw or positive displacement type, wherein the compressor in turn is fed with e g natural gas from an external supply. This increase of the fuel gas pressure before the fuel gas enters the combustion chamber of the gas turbine is required due to an often too low fuel gas pressure delivered by an external supplier.

The injection of fuel is controlled by control means, regulator and shut-off valves, and associated equipment for supplying the appropriate mass flow of fuel into the combustion chamber. The pressure of the gaseous fuel entering the combustion chamber can be controlled by various computer software and hardware, mechanical or electrical valves and/or other control means in response to a measured pressure drop across certain parts of the fuel system for the gas turbine unit, e g the turbine, conduits or any other suitable part of the unit.

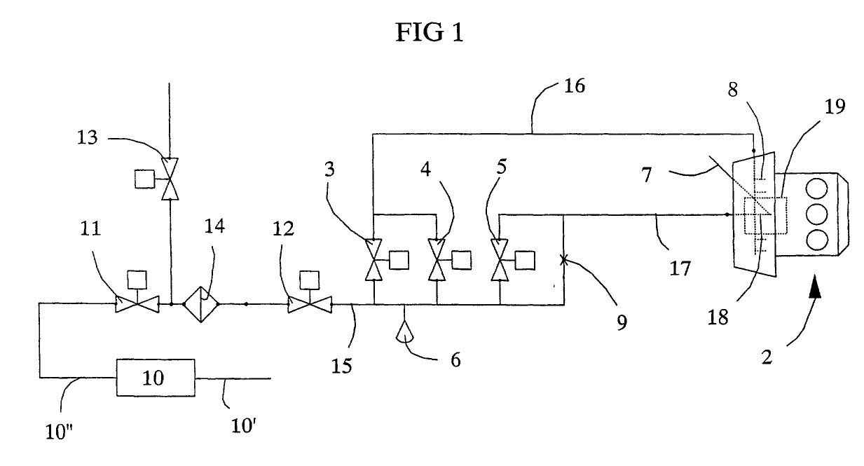

In a preferred embodiment of a fuel injection system, as shown in FIG. 1, pressurized natural gas is used as a fuel gas supplied to a combustion chamber 2 of a gas turbine, which is not further illustrated. The fuel gas is supplied from an external source to an inlet side 10′ of a fuel gas compressor 10, which pressurizes the fuel gas in a way known to a man skilled in the art, and delivers the fuel gas with an appropriate higher pressure to the outlet side 10″ connected to a gas supply conduit 15. A first shut-off valve 11 is connected with its upstream end to the gas supply conduit, and with its downstream end to a gas filter 14. This first shut-off valve is used for closing and opening the fuel gas mass flow. A fuel gas evacuation conduit with a fuel gas evacuation valve 13 is connected to the gas supply conduit between the first shut-off valve and the gas filter for evacuating leaking or remaining fuel gas in the gas supply conduit during stops and standstills for the gas turbine unit. A second shut-off valve 12 is connected with its upstream end to the downstream end of the gas filter. The fuel gas evacuation is done as a security measure when stopping the gas turbine by closing the fuel gas massflow by means of the shut-off valves 11 and 12, wherein a time delay or an error in the closing procedure could enclose fuel gas in the gas supply conduit, which then has to be evacuated. It could also occur a function error in any of the shut-off valves creating a leaking of fuel gas into the gas supply conduit that also has to be evacuated.

The fuel injection system comprises two controllable main valves 3, 4, each connected with its upstream end to the gas supply conduit 15 after the second shut-off valve 12. The first main valve 3 is connected to the gas supply conduit after the second shut-off valve and the second main valve 4 is connected to the gas supply conduit after the first main valve. The two main valves 3, 4 are arranged in parallel to each other, whereby their downstream ends are connected to a conduit 16 leading into the combustion chamber 2. The two main valves are electrically controllable magnetic valves working with pulse-width-modulation, i e controlling the fuel gas mass flow by varying the length of their opening time pulses in relation to their closing time. Due to practical and technical reasons two main valves are used, but an option is to use only one valve if possible. A pressure transducer 6 is also connected to the gas supply conduit 15 between the upstream ends of the two main valves 3, 4 for measuring the pressure of the fuel gas before entering the main valves.

A pilot valve 5 is connected with its upstream end to the gas supply conduit 15 after the second main valve 4, and with its downstream end connected to another conduit 17 leading into the combustion chamber 2. The pilot valve 5 is also an electrically controllable magnetic valve, working with pulse-width-modulation, i e controlling the gas flow by varying the length of its opening time pulses in relation to its closing time. A throttle valve 9 is connected with its upstream end to the gas supply conduit 15 after the pilot valve, and its downstream end connected to the same conduit 17 as the pilot valve leading into the combustion chamber, whereby the throttle valve is connected in parallel with the pilot valve and lets through a constant fuel gas mass flow for ensuring a continuous combustion in the combustion chamber.

The conduit 16 is connected to the downstream ends of the two main valves 3 and 4, and leads the fuel gas into fuel gas injection nozzles 8 placed in the combustion chamber 2 of the gas turbine. These nozzles are arranged in a ring form around a pilot flame chamber 19 inside the combustion chamber for creating an even distribution of injected fuel gas giving an efficient combustion. The conduit 17 is connected to the downstream ends of the pilot valve 5 and the throttle valve 9 and leads the fuel gas into a pilot nozzle 18 in the centre of the combustion chamber 2 and the pilot flame chamber 19. The pilot flame chamber surrounds the pilot nozzle for ensuring that a pilot flame becomes and is kept stable without disturbances.

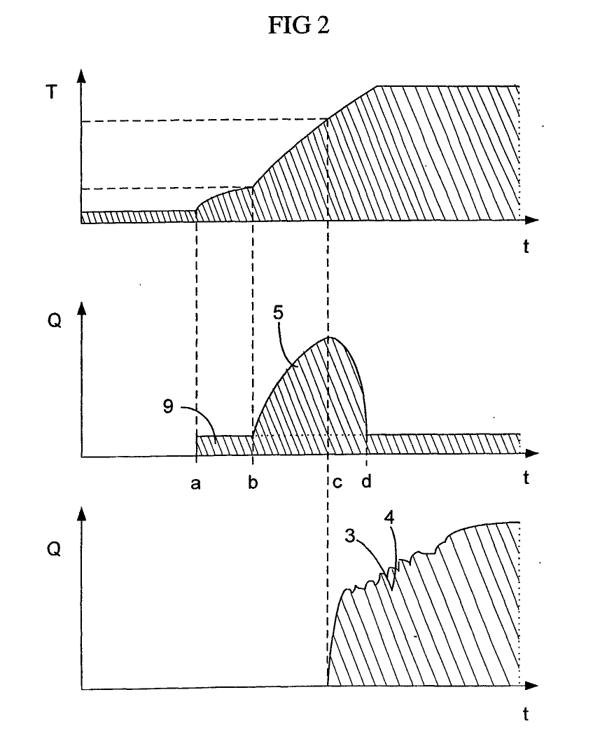

A description will now be given of a method for operating the combustion chamber 2 of a gas turbine by using the fuel injection system according to the invention, the injection nozzles 8, and an igniter 7, which is placed inside the combustion chamber with its end inside the pilot flame chamber 19 near the outlet of the pilot nozzle 18 for igniting the pilot flame. The method is explained with reference to FIG. 2, in which the top diagram schematically shows the temperature T in the combustion chamber 2 on the y-axis in relation to time t shown on the x-axis, the diagram in the middle schematically shows the fuel gas mass flow Q through the pilot valve 5 and the throttle valve 9 on the y-axis in relation to time t shown on the x-axis, and the bottom diagram shows the fuel gas mass flow Q through the main valves 3 and 4 on the y-axis in relation to time t shown on the x-axis.

The method involves the consecutive steps of first evacuating possible remaining fuel in the combustion chamber 2 by means of a draught created by rotating the gas turbine, e g by means of an electric generator on the turbine shaft used as a motor. Then the igniter 7 is energized a certain time before point “a” in FIG. 2 for about ten seconds, and pressurized fuel gas is supplied in the gas supply conduit 15 about two seconds after the igniter is energized. This is followed by igniting the fuel gas supplied from the gas supply conduit through the throttle valve 9 connected to the conduit 17 leading into the combustion chamber, whereby the pilot flame is created at point “a” in FIG. 2, and waiting until the pilot flame is stable, hereby starting to warm up the combustion chamber as seen in the top diagram of FIG. 2.

Then the pilot valve 5 in parallel with the throttle valve is energized at point “b” in the middle diagram so that the pilot flame can be regulated for achieving a predefined higher temperature in the combustion chamber 2, and the two main valves 3 and 4, shown in the bottom diagram, are energized at point “c”, and the pilot valve 5 is closed at point “d”, ensuring an overlapping of fuel gas mass flow, when the combustion chamber has an appropriate temperature. The method ensures that the operation of the gas turbine can be regulated by supplying the appropriate mass flow of fuel gas. The pilot valve 5 may be regulated simply by closing or opening it completely or be regulated in response of transient/dynamic conditions in the gas turbine. The latter preferred way of regulating the pilot valve is accomplished by regulating it in response of changes in e g, temperature in the gas turbine, number of revolutions for the gas turbine, i e load and power demand for the gas turbine, and air flow through the gas turbine. This means that the pilot valve instead of being closed at point “d” as described above is regulated together with the two main valves.

A summarizing description of a method for starting the gas turbine will now be given by using the fuel injection system according to the invention, the injection nozzles 8, and the igniter 7, wherein this method involves an additional step besides all the steps described in the above mentioned method. This additional step is executed before the evacuation of fuel gas from the combustion chamber, and concerns switching on the voltage supply to the shut-off valves 11, 12, the fuel gas evacuation valve 13, and the gas filter 14 at the same time. This is followed by the chronological steps described in the above-mentioned method for operating the combustion chamber 2.

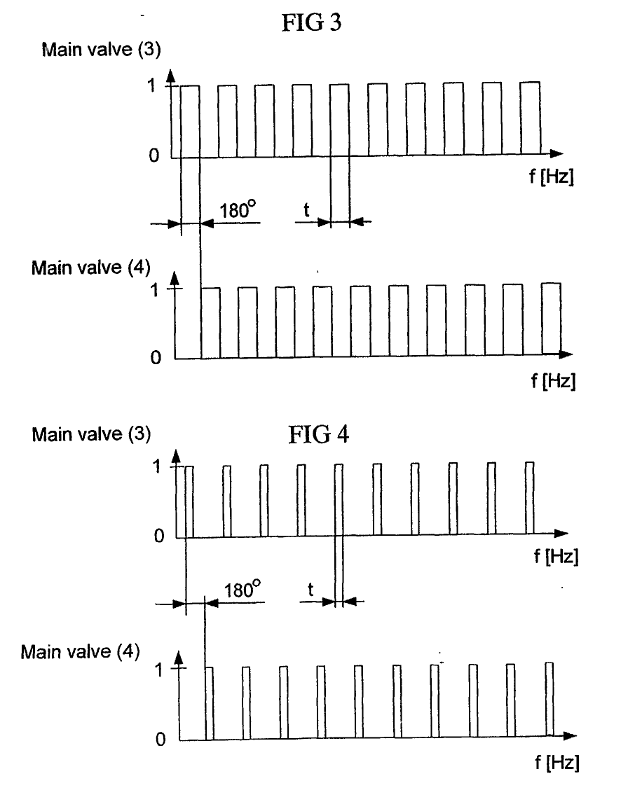

FIGS. 3 and 4 illustrate the operation of the main valves 3 and 4 during the pulse-width-modulation. The opening and closing frequency is shown on the x-axis and the open state of the valves is shown with 1 and the closed state with 0 on the y-axis. The transition between the two states is schematically shown without the time delay or hysteresis when each valve moves from the closed state to the open state and vice versa for clarity reasons. FIG. 3 shows the operation of the main valves 3 and 4 when each of them is open 50% of the whole working-cycle. The main valves are opened and closed during operation with the same constant frequency, preferably 25 Hz, and have a constant phase displacement in relation to each other when operating. The preferred phase displacement between them is 180°, any other phase displacement in the interval 0° to 360° fulfilling the demands could also be used. FIG. 4 shows the operation of the main valves in relation to each other when each of them is open only 20% of the whole working-cycle. Here can be seen that the first main valve 3 opens and closes before the second main valve 4 is opened in comparison with FIG. 3 in which the first main valve 3 closes and the second main valve 4 opens at approximately the same time.

The two main valves 3, 4 and the pilot valve 5 are controlled in relation to the load and power demand of the gas turbine. This control can be done in accordance with different parameters, e g the temperature in the combustion chamber 2 and the gas turbine, and its number of revolutions, wherein these are measured creating signals, indicating fuel gas mass flow conditions, load and/or power demands or other requirements.

Furthermore, the throttling, i e the throttling function accomplished with the throttle valve 9 in this embodiment, may be done by by-passing fuel gas flow, or by using a common adjustable throttle valve or a throttle valve with a fixed throttle value.

1. Fuel injection system for supplying pressurized fuel gas to a combustion chamber (2) of a gas turbine, the fuel injection system having at least one electrically controllable magnetic valve (3, 4, 5) working with pulse-width-modulation, i e controlling the gas flow by varying the length of its opening time pulses in relation to its closing time, in a gas supply conduit (15),
characterized in that at least one electrically controllable magnetic main valve (3, 4) is arranged in the supply conduit (15) and
that at least one pilot valve (5) is connected to the supply conduit with its upstream end after the main valve and with its downstream end connected to a conduit (17) leading into a pilot flame chamber (19) inside the combustion chamber (2).

2. Fuel injection system according to claim 1, wherein the two main valves, a first and a second main valve (3, 4), are arranged in parallel in the supply conduit (15) and the at least one pilot valve (5) is connected to the supply conduit after the second main valve (4).

3. Fuel injection system according to claim 2, wherein a pressure transducer (6) is connected to the supply conduit (15) between the upstream ends of the two main valves (3, 4).

4. Fuel injection system according to claim 2, wherein a throttle valve (9) is connected to the supply conduit (15) with its upstream end after the pilot valve (5), and its downstream end connected to the conduit (17) leading into the pilot flame chamber (19), whereby the throttle valve is connected in parallel with the pilot valve (5) and lets through a constant fuel gas flow for ensuring a continuous combustion in the combustion chamber (2).

5. Fuel injection system according to claim 2, wherein the two main valves (3, 4) and the pilot valve (5) are controlled in relation to the actual load for the gas turbine, i e the temperature in the combustion chamber (2) and the gas turbine, and its number of revolutions.

6. Fuel injection system according to claim 2, wherein the main valves (3, 4) are opened and closed with the same constant frequency but have a phase displacement in relation to each other when operating.

7. Fuel injection system according to claim 6, wherein the phase displacement for the main valves (3, 4) is 180° in relation to each other.

8. Fuel injection system according to claim 4, wherein the fuel injection system also has a fuel gas compressor (10) with a fuel gas inlet side (10′) and a fuel gas outlet side (10″), a gas filter (14), and connecting means,
characterized in that a first shut-off valve (11) is connected to the outlet side (10″) of the fuel gas compressor (10) so that the fuel gas mass flow can be stopped,
that a fuel gas evacuation valve (13) is connected between the first shut-off valve (11) and the gas filter (14) connected to the gas supply conduit (15) after the first shut-off valve (11),
that a second shut-off valve (12) is connected with its upstream end after the gas filter (14), and connected with its downstream end to the upstream end of the first main valve (3) by means of the gas supply conduit (15).

9. Method for operating a combustion chamber (2) of a gas turbine by means of the fuel injection system according to claim 4, the fuel injection system also comprising at least one fuel gas igniter (7) and at least one fuel gas injection nozzle (8) in the combustion chamber,
characterized by the chronological steps of
evacuating possible remaining fuel gas in the combustion chamber (2) by means of a draught created by rotating the gas turbine,
energizing the igniter (7) for about ten seconds,
supplying pressurized fuel gas in the gas supply conduit (15) about two seconds after the igniter is energized,
igniting the fuel gas supplied from the gas supply conduit through the throttle valve (9) connected to the separate conduit (17) leading into the pilot flame chamber (19) inside the combustion chamber, whereby a pilot flame is created, and waiting until the pilot flame is stable,
energizing the pilot valve (5) in parallel with the throttle valve so that the pilot flame can be regulated for achieving a predefined temperature in the combustion chamber, and
energizing the two main valves (3, 4) and closing, alternatively, regulating the pilot valve (5) when the combustion chamber has an appropriate temperature, whereby the operation of the gas turbine can be regulated by supplying the appropriate flow of fuel gas.

10. Method for starting a gas turbine by means of the fuel injection system according to claim 8,
characterized by the chronological steps of
switching on the voltage supply to the shut-off valves (11, 12), the fuel gas evacuation valve (13), and the gas filter (14) at the same time,
evacuating possible remaining fuel in the combustion chamber (2) of the gas turbine by means of a draught created by rotating the gas turbine,
energizing the igniter (7) in the combustion chamber for about ten seconds,
closing the fuel gas evacuation valve (13), which is open during stops and standstills for the gas turbine,
energizing the shut-off valves (11, 12), preferably, about two seconds after the igniter is energized, thereby leading a small flow of fuel gas through the gas supply conduit (15) into the throttle valve (9) connected to the separate conduit (17) leading into the combustion chamber; the main valves (3, 4) and the pilot valve (5) remaining closed,
igniting the fuel gas supplied to the combustion chamber through the throttle valve, whereby a pilot flame is created, and waiting until the pilot flame is stable,
energizing the pilot valve (5) in parallel with the throttle valve so that the pilot flame can be regulated achieving a predefined temperature in the combustion chamber, and
energizing the two main valves (3, 4) and closing, alternatively, regulating the pilot valve (5) when the combustion has an appropriate temperature, whereby the operation of the gas turbine can be regulated by supplying the appropriate flow of fuel.
